(19) United States
(12) Patent Application Publication
(10) Pub. No.: US 2015/0117407 A1
(43) Pub. Date: Apr. 30, 2015

(54) Adapting Uplink Transmissions in a Wireless Telecommunications Network

(71) Applicant: Telefonaktiebolaget L M Ericsson (publ), Stockholm (SE)

(72) Inventors: Billy Hogan, Sollentuna (SE); Ari Kangas, Lidingo (SE); Cagatay Konuskan, Stockholm (SE)

(21) Appl. No.: 14/399,988

(22) PCT Filed: Apr. 24, 2014
(86) PCT No.: PCT/SE2014/050499

§ 371 Date: Nov. 10, 2014

Related U.S. Application Data
(60) Provisional application No. 61/817,335, filed on Apr. 30, 2013.

(51) Int. Cl. H04W 36/00; H04W 36/18

(52) U.S. Cl. CPC H04W 36/0055; H04W 36/18
USPC 370/331

(57) ABSTRACT

Methods in a node in a wireless telecommunications network are provided. A method in a node in a wireless telecommunications network may include providing an uplink data rate offset value to a serving base station for transmission to a wireless terminal that is in a soft handover. The method may include providing a power budget for the wireless terminal to a non-serving base station of the wireless terminal. Moreover, the method may include providing a Signal-to-Interference-plus-Noise Ratio, SINR, target value to the non-serving base station. Related nodes and wireless terminals are also provided.

### TECHNICAL FIELD

The present disclosure is directed to communications and, more particularly, to wireless communications.

### BACKGROUND

Communication devices such as User Equipments, UE, are also known as, e.g., mobile terminals, wireless terminals, wireless devices and/or mobile stations. User equipments are enabled to communicate wirelessly in a wireless communication(s) system, sometimes also referred to as a cellular radio system or a cellular network. The communication may be performed, e.g., between two user equipments, between a user equipment and a regular telephone and/or between a user equipment and a server via a Radio Access Network, RAN, and possibly one or more core networks, comprised within the wireless communications system.

User equipments may further be referred to as mobile telephones, cellular telephones, or laptops with wireless capability, just to mention some further examples. The user equipments in the present context may be, for example, portable, pocket-storable, hand-held, computer-comprised, or vehicle-mounted mobile devices, enabled to communicate voice and/or data, via the RAN, with another entity, such as another user equipment or a server.

The wireless communications system covers a geographical area that is divided into cell areas, where each cell area is served by a base station, e.g., a Radio Base Station, RBS, which sometimes may be referred to as e.g. “eNB”, “eNodeB”, “NodeB”, “B node”, or BTS, Base Transceiver Station, depending on the technology and terminology used. The base stations may be of different classes such as, e.g., macro eNodeB, home eNodeB or pico base station, based on transmission power and thereby also cell size. A cell is a geographical area where radio coverage is provided by the base station at a base station site. One base station, situated on the base station site, may serve one or several cells. Further, each base station may support one or several communication technologies. The base stations communicate over the air interface operating on radio frequencies with the user equipments within range of the base stations.

In some RANs, several base stations may be connected, e.g. by landlines or microwave, to a radio network controller, e.g. a Radio Network Controller, RNC, in Universal Mobile Telecommunications System, UMTS, and/or to each other. The radio network controller, also sometimes termed a Base Station Controller, BSC, e.g. in GSM, may supervise and coordinate various activities of the plural base stations connected thereto. GSM is an abbreviation for Global System for Mobile Communications.

In 3rd Generation Partnership Project, 3GPP, Long Term Evolution, LTE, base stations, which may be referred to as eNodeBs or even eNBs, may be directly connected to one or more core networks.

UMTS is a third generation mobile communication system, which evolved from the GSM, and is intended to provide improved mobile communication services based on Wideband Code Division Multiple Access, WCDMA, access technology. UMTS Terrestrial Radio Access Network, UTRAN, is essentially a radio access network using WCDMA for user equipments.

High-Speed Packet Access, HSPA, is a mobile communication technology that further extends and improves the performance of UMTS. Two standardized solutions, High-Speed Downlink Packet Access, HSDPA, and High-Speed Uplink Packet Access, HSUPA, have been established. The latter, HSUPA, may also be referred to as HSPA Enhanced Uplink, HSPA EUL, or simply as Enhanced Uplink, EUL. The purpose of the EUL is in general to improve the performance of uplink dedicated transport channels, so as to increase capacity and throughput and reduce delay.

A UE which has been scheduled to use EUL basically uses three uplink dedicated physical channels: DPCCH, E-DPDCH and E-DPCCH. DPCCH, Dedicated Physical Control Channel, is used to transmit known pilot bits used by the Node B for synchronization and channel estimation. In addition, the DPCCH may comprise e.g. power control commands to be used in the downlink. E-DPDCH, Enhanced-Dedicated Channel (E-DCH) Dedicated Physical Data Channel, carries the actual user data. E-DPCCH, E-DCH Dedicated Physical Control Channel, carries information about the format of the actual user data sent on the E-DPDCH.

These uplink dedicated physical channels may comprise information, such as, e.g. an E-DCH Transport Format Combination Identifier, ETFCI, which may comprise information about the transport block set size, from which the Node B may determine the number of information bits, spreading factors and modulation used in the transmission; a Retransmission Sequence Number, RSN, which informs the Node B about which coded bits are sent; or a bit, commonly referred to as a “happy bit”, which may indicate to the Node B that the UE would like to transmit at a higher rate.

For the EUL and the uplink dedicated physical channels therein, some of the important aspects relate to power control and bit rate adaptation.

Fast uplink power control is an important feature of all CDMA systems, since a number of users typically share the same air interface resource. The operation of the so-called Inner and Outer Loop Power Control, ILPC and OLPC, is illustrated in FIG. 1. FIG. 1 shows loops of the ILPC and the OLPC in a baseline scheme.

The ILPC is based on Transmit Power Control, TPC, commands. The TPC commands are transmitted from the Node B to the UE each slot, i.e. 2/3 ms, and orders the UE to increase or decrease the power of the DPCCH channel. The power of the other dedicated physical channels, E-DPDCH and E-DPCCH, and also e.g. HS-DPCCH, are defined in relation to DPCCH. This is may be seen in FIG. 2.

Hence, TPC commands serve normally to increase the total transmit power of the UE. The TPC commands are typically used to control the Signal-to-Interference-plus-Noise Ratio, SINR, to a level at which control and data channels may be reliably detected in order to achieve a certain Block Error Rate, BLER, for the E-DPDCH. The control of the BLER is performed by an outer loop in which the OLPC algorithm changes the Signal-to-Interference Ratio, SIR, target based on measured BLER. This is also indicated and may be seen in FIG. 1.

The bitrate of a UE is controlled by the Node B by sending an Absolute Grant, AG, which may be relative, to the UE. This may be performed at most once per Transmit Time Interval, TTI, which may be each 2 ms or 10 ms for EUL. The value of AG provides the UE with an allowed power offset on the E-DPDCH channel relative to the DPCCH power. In addition, the value of AG may be used in determining the maximum bit rate that the UE may use.

In the WCDMA uplink, the received power in the Node B is the shared resource. Hence, the Node B will attempt to control the so-called Rise-over-Thermal, RoT, power. The RoT is the total received power divided by the thermal noise power in the Node B. The higher the RoT becomes, the less stable the system will become. Therefore, the scheduling in the Node B takes into account the maximum allowed RoT when it determines the AG and DPCCH power for each UE. Based on the available power for the UE, the Node B sends an AG to the UE. As the AG are sent on a TTI basis by the Node B, the total loop delay is considerably longer than the Inner Loop Power Control, ILPC, delay. The total loop delay is at least 6 ms longer, but could in practice be much longer. The scheduling in the Node B may measure the actual total received power of the UE and check if it is within a target power. If the actual total received power of the UE is too large, the AG may be decreased. Otherwise, the AG may e.g. be increased.

However, this procedure may lead to RoT stability problems for many reasons. For example, the measured SINR depends, e.g., on the type of receiver that is deployed. If, e.g. a so-called Interference Suppression, IS, receiver is used, then the resulting SINR depends in a complicated manner on the combination of the own and other UEs propagation channels and powers. For a UE transmitting at high rates, which is equivalent to high SINRs and high power offset between E-DPDCH and DPCCH, the so-called self-interference also starts to influence the SINR. This is illustrated and may be seen in FIG. 2, which depicts SINR levels mapped to received power, S, at the Node B.

As may be seen in FIG. 2, above a certain power level, A, an increase in the total received power does not result in increased SINR, but rather flattens out the SINR. If the SINR target is above this level, then a power rush will occur. This power rush will then cause all other UEs in the cell, and also to some extent UEs in neighboring cells, to increase their powers in order to reach their SINR targets. This kind of power rush may also occur when a UE, perhaps located in a different cell, suddenly starts to transmit at a high rate, thus creating an instantaneous increased RoT.

Eventually the scheduling, e.g. via a scheduler, in the Node B may detect that the RoT has surpassed the target, and may then transmit new reduced AGs for the UEs that are within the Node B's control. However, as the granting mechanism in the Node B is much slower, e.g. around at least 10 times slower, than the ILPC, this is not easily performed.

Therefore, typically, other emergency measures must be used, such as, e.g., temporarily overriding the ILPC and forcing down the UE transmit powers before the new AGs have been received by the UEs. After the RoT has been reduced, the scheduling in the Node B again needs to upgrant the UEs, i.e., increase the AGs again. If this is performed in an aggressive manner, then the system is de facto operating in an on/off mode or manner. Alternatively, the scheduling in the Node B may also be configured to act in an overly conservative way and only upgrant the UEs very slowly so as to reduce/avoid power rushes. However, neither of these alternatives appear to use the full potential of the air interface.

The approaches described in this Background section could be pursued, but are not necessarily approaches that have been previously conceived or pursued. Therefore, unless otherwise expressly stated herein, the approaches described in this Background section are not prior art to the claims in this application and are not admitted to be prior art by inclusion in this section.

### SUMMARY

Various embodiments provide a method in a node in a wireless telecommunications network. The method includes providing an uplink data rate offset value to a serving base station for transmission to a wireless terminal that is in a soft handover. The method includes providing a power budget for the wireless terminal to a non-serving base station of the wireless terminal. Moreover, the method includes providing a Signal-to-Interference-plus-Noise Ratio, SINR, target value to the non-serving base station.

A node configured to provide communications with a wireless terminal of a wireless telecommunications network through serving and non-serving base stations, according to various embodiments, is provided. The node includes a network interface configured to provide communications with the serving and non-serving base stations. Moreover, the node includes processing circuitry coupled to the network interface. The processing circuitry is configured to provide an uplink data rate offset value through the network interface to the serving base station for transmission to the wireless terminal, when the wireless terminal is in a soft handover. The processing circuitry is configured to provide a power budget for the wireless terminal, through the network interface to the non-serving base station. Moreover, the processing circuitry is configured to provide a Signal-to-Interference-plus-Noise Ratio, SINR, target value through the network interface to the non-serving base station.

A method in a node in a wireless telecommunications network, according to various embodiments, is provided. The method includes receiving an uplink data rate offset value from a Radio Network Controller. The method includes transmitting the uplink data rate offset value to a wireless terminal that is in a soft handover. The method includes determining a power budget for the wireless terminal. The method includes transmitting the power budget to the Radio Network Controller for transmission to a non-serving base station. Moreover, the method includes transmitting to the Radio Network Controller an indication requesting a change (e.g., an increase or a decrease) of a Signal-to-Interference-plus-Noise Ratio, SINR, target value.

A node in a wireless telecommunications network, according to various embodiments, is provided. The node includes radio circuitry configured to provide communications with a wireless terminal that is in a soft handover. The node includes a network interface configured to provide communications with a Radio Network Controller. Moreover, the node includes processing circuitry coupled to the radio circuitry and the network interface. The processing circuitry is configured to receive an uplink data rate offset value from the Radio Network Controller through the network interface. The processing circuitry is configured to transmit the uplink data rate offset value to the wireless terminal that is in the soft handover. The processing circuitry is configured to determine a power budget for the wireless terminal. The processing circuitry is configured to transmit the power budget to the Radio Network Controller for transmission to a non-serving base station. Moreover, the processing circuitry is configured to transmit to the Radio Network Controller an indication requesting a change (e.g., an increase or a decrease) of a Signal-to-Interference-plus-Noise Ratio, SINR, target value.

A method in a wireless terminal, according to various embodiments, is provided. The method includes transmitting an uplink data block to a non-serving base station and/or a serving base station when the wireless terminal is in a soft handover with respect to the serving base station and the non-serving base station. The method then includes receiving an uplink data rate offset value from the serving base station. The method includes receiving a first power control command from the serving base station. The first power control command requests a change in total transmit power of (e.g., total power of transmissions by) the wireless terminal. Moreover, the method includes receiving a second power control command from the serving base station. The second power control command requests a change in Dedicated Physical Control Channel, DPCCH, transmit power of the wireless terminal.

A wireless terminal, according to various embodiments, includes radio circuitry configured to provide communications with a non-serving base station and a serving base station. The wireless terminal includes processing circuitry coupled to the radio circuitry. The processing circuitry is configured to transmit, through the radio circuitry, an uplink data block to the non-serving base station and/or the serving base station when the wireless terminal is in a soft handover with respect to the serving base station and the non-serving base station. The processing circuitry is configured to then receive, through the radio circuitry, an uplink data rate offset value from the serving base station. The processing circuitry is configured to receive, through the radio circuitry, a first power control command from the serving base station. The first power control command requests a change in total transmit power of (e.g., total power of transmissions by) the wireless terminal. Moreover, the processing circuitry is configured to receive, through the radio circuitry, a second power control command from the serving base station. The second power control command requests a change in Dedicated Physical Control Channel, DPCCH, transmit power of the wireless terminal.

Various embodiments described herein may improve uplink transmissions from a user equipment in a wireless telecommunications system. For example, operations described herein may be performed by a network node to adapt the power and bit rate of transmissions received from a user equipment in a wireless telecommunications network. The network node may adapt the maximum bit rate for transmissions to be received from the user equipment based on a threshold value of the allowed power offset for transmissions from the user equipment. This may be performed by the network node, while the network node may maintain a determined level of at least one received power of the transmissions from the user equipment.

By maintaining at least one received power level at the network node of the transmissions received from a user equipment at a certain level, and adapting the maximum bit rate based a threshold target value of the allowed power offset for transmissions from the user equipment, fluctuating power levels, or power rushes, in unstable user equipments may be reduced/avoided. This may improve the power control and bit rate adaptation in uplink transmissions from a user equipment, and may lead to a more predictable and stable wireless telecommunications system.

Hence, uplink transmissions from a user equipment in a wireless telecommunications system may be improved. For example, some embodiments may improve soft handover performance by specifying how base stations should perform power measurements and how to distribute information between base stations.

### BRIEF DESCRIPTION OF THE DRAWINGS

Features and advantages of the embodiments will become readily apparent to those skilled in the art by the following detailed description of exemplary embodiments thereof with reference to the accompanying drawings.

FIG. 1 is a schematic flow diagram depicting loops of the ILPC and the OLPC in a baseline scheme.

FIG. 2 is a schematic diagram depicting depicts SINR levels mapped to received power, S, at the network node.

FIG. 3 is a schematic block diagram illustrating embodiments in a wireless communications network.

FIG. 4 is a schematic flow diagram illustrating the power control and bit rate adaptation according to some embodiments.

FIG. 5 is a further schematic flow diagram illustrating the power control and bit rate adaptation according to some embodiments.

FIG. 6 is a block diagram depicting embodiments of a network node.

FIG. 7 is a block diagram depicting embodiments of a user equipment.

### DETAILED DESCRIPTION

The figures are schematic and simplified for clarity, and they merely show details which are may be useful/essential to the understanding of the embodiments presented herein, while other details may have been left out. Throughout, the same reference numerals are used for identical or corresponding parts or steps.

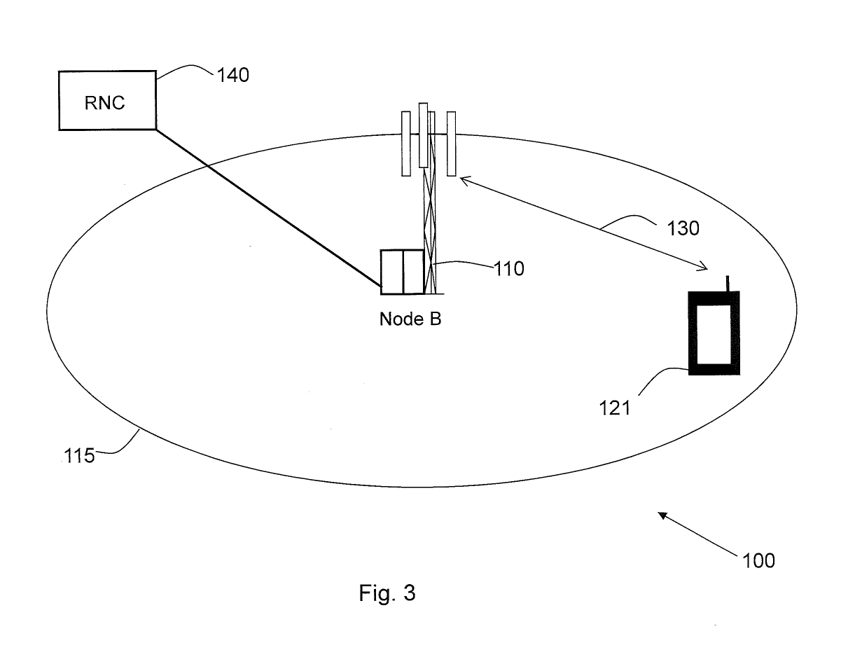

FIG. 3 depicts a telecommunications system 100 in which embodiments herein may be implemented. The cellular communications system 100 is a wireless communication network such as an HSPA, WCDMA, GSM network, or any similar cellular network or system.

The telecommunications system 100 may include a network node 110, which may be a base station. The network node 110 serves a cell 115. The network node 110 may in this example e.g. be an Node B, B node, an eNB, an eNodeB, or a Home Node B, a Home eNode B, a femto Base Station (BS), a pico BS or any other network unit capable to serve a user equipment or a machine type communication device which are located in the cell 115 in the telecommunications system 100.

A user equipment 121 is located within the cell 115. The user equipment 121 is configured to communicate within the telecommunications system 102 via the network node 110 over a radio link 130 when the user equipment 121 is present in the cell 115 served by the network node 110. The user equipment 121 may, e.g., be a mobile terminal, a wireless terminal, a mobile phone, a computer, such as, e.g., a laptop, a Personal Digital Assistant (PDA) or a tablet computer with wireless capability, a device equipped with a wireless interface, such as a printer or a file storage device or any other radio network unit capable of communicating over a radio link in a telecommunications system.

The network node 110 may be connected to a Radio Network Controller 140, RNC, in the telecommunications system 100. The RNC 140 may control a large number of network nodes connected to it, such as, e.g. the network node 110. The RNC may, for example, perform radio resource management and some mobility management functions for these network nodes. The RNC connects the network node 110 to the core network of the telecommunications system 100. The RNC 140 may also be referred to as a network node.

As part of the developing of the embodiments described herein, some issues will first be discussed in more detail.

First, it should be noted that rate adaptation or bit rate adaptation is commonly used to denote a family of methods designed for stabilizing the EUL uplink performance in HSPA/WCDMA systems in order to reduce/avoid excessive power rushes or fluctuating power levels.

Existing methods for power control and bit rate adaptation may include and/or consist of granting a certain bit rate the user equipment. Then, the SIR target for the transmissions from the user equipment is adapted to achieve a certain Block Error Rate, BLER, level at the already granted bit rate. In this rate adaptation, the bit rate is granted in order to provide a certain BLER level given a total power budget for the transmissions from the user equipment.

Furthermore, the operation of these existing methods in soft handover, i.e. a soft handover procedure of the user equipment, is difficult and complicated.

In some embodiments, the network node 110, 140 may initially determine a power-over-thermal-noise target value, E_{c}/N₀, for the transmissions from the user equipment 121. This power-over-thermal-noise target value, E_{c}/N₀, may also be referred to as a E_{c}/N₀ target or E_{c}/N₀ target value. The E_{c}/N₀ target may be based on the available air interface load or headroom for the transmissions from the user equipment (121). Here, the network node 110, 140 may be a Node B 110.

Also, in some embodiments, the network node 110, 140 may initially determine an initial threshold value for the amount of reliably detected transmissions from the user equipment 121, i.e. an initial grant value or offset of a grant value. Here, the network node 110, 140 may take into account e.g. the buffer status of the user equipment 121, the available E_{c}/N₀ target for the transmissions from the user equipment 121 and the desired SIR target value on the control channel.

The network node 110 may include a scheduler 420, or scheduling unit, which may be configured to perform the Actions 1-4 described below in any suitable order. Also, here, Ptx 410 denotes the received DPCCH power of the transmissions from the user equipment 121. Here, the relative powers allocated to E-DPDCH 411, E-DPCCH 412, and DPCCH 413, respectively. The area 411, or AG maximum Bed, may thus be seen as corresponding to the power offset of the E-DPDCH relative to the DPCCH power.

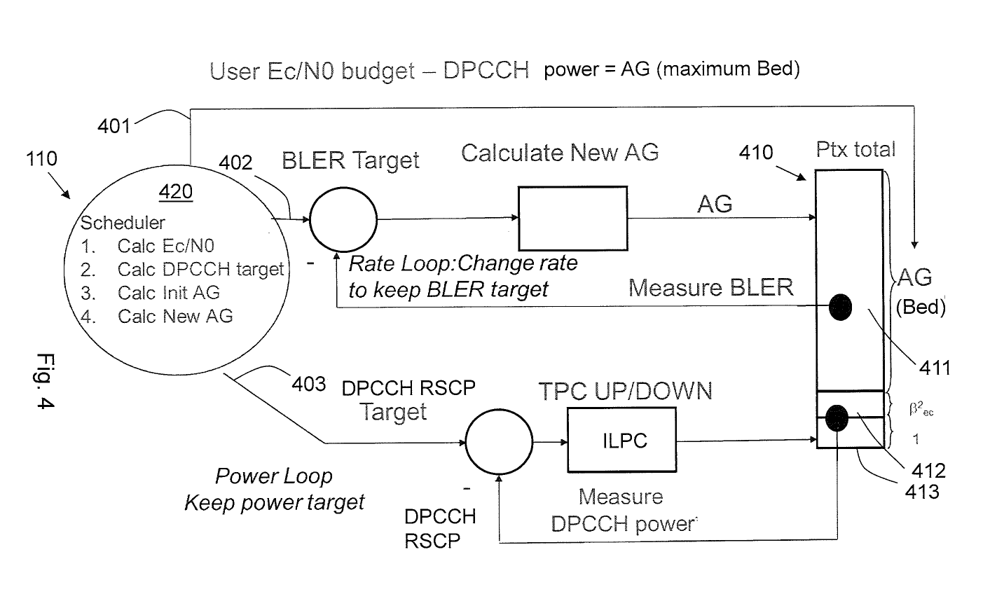

The network node 110 may also calculate an initial Absolute Grant, AG, for the user equipment 121. This calculation may take into account e.g. the buffer status of the user equipment 121, the available Ec/N0 and the desired SIR target on the control channel. This initial grant value calculation 401 is shown in upper part of FIG. 4.

In the middle part of FIG. 4, the grant calculation 402 may be performed in the network node 110, 140, i.e. either in the Node B 110 alone or by combining information from the Node B 110 and the RNC 140.

In any case the grant calculation 402 may be based on BLER statistics. If BLER is higher than the desired BLER target, then the grant may be lowered. If the BLER is lower than the desired BLER target, then the grant may be increased. The network node 110 may then transmit the new grant to the user equipment 121.

Then, the user equipment 121 may lower/increase the bit rate of its transmissions, and, e.g., change the ratio between E-DPDCH and DPCCH. However, since the total power of the transmission from the user equipment 121 is still maintained by the ILPC 403 in the network node 140, the effect is that the network node 110 will receive more/less energy per information bit. This means that the BLER value may be kept close to its desired BLER target by the network node 110.

For some embodiments, some details will now be discussed below regarding, e.g., operation of the network nodes 110, 140 and the user equipment 121 in soft handover, network signalling between the network nodes 110, 140 and the user equipment 121, and precise calculations which may be performed by the user equipment 121 to maintain DPCCH SIR and total received power of the transmission from the user equipment 121 simultaneously.

Some embodiments herein adapt to the channel conditions to get good enough DPCCH SINR and data BLER in order to achieve increased bit rates and/or as high bit rates as possible within the allowed power budget of the user equipment 121. It should, however, be noted that a low DPCCH SINR may result in performance degradation due to potential problems with keeping required quality levels on the control channels. Also, a high DPCCH SINR may result in inefficient utilization of the power budget and excessive uplink interference. Therefore, in the embodiments above, a mechanism is described for decoupling the bit rate from the transmitted power in order to keep a desirable BLER level.

In some embodiments, the rate adaptation scheme enables a stable operation while keeping control over the total received power from the user equipment 121 at the Node B 110 by decoupling the power budget given to the user equipment 121 from the actual selected E-TFCI (bit rate) for the user equipment 121. If there is a growing difference between the received SINR and the received power, e.g. due to increased Inter-Symbol Interference, ISI, then the NodeB 110 may send some information to the user equipment 121 notifying this. This conveyed information may then be used by the user equipment 121 to adjust the selected E-TFCI (bit rate) to the channel conditions, while keeping the allowed power budget. This type of rate adaptation scheme allows control over received power, while data BLER level is also kept stable. Ideally, DPCCH SINR should not be allowed to suffer and some mechanism may be used for also protecting the DPCCH quality level.

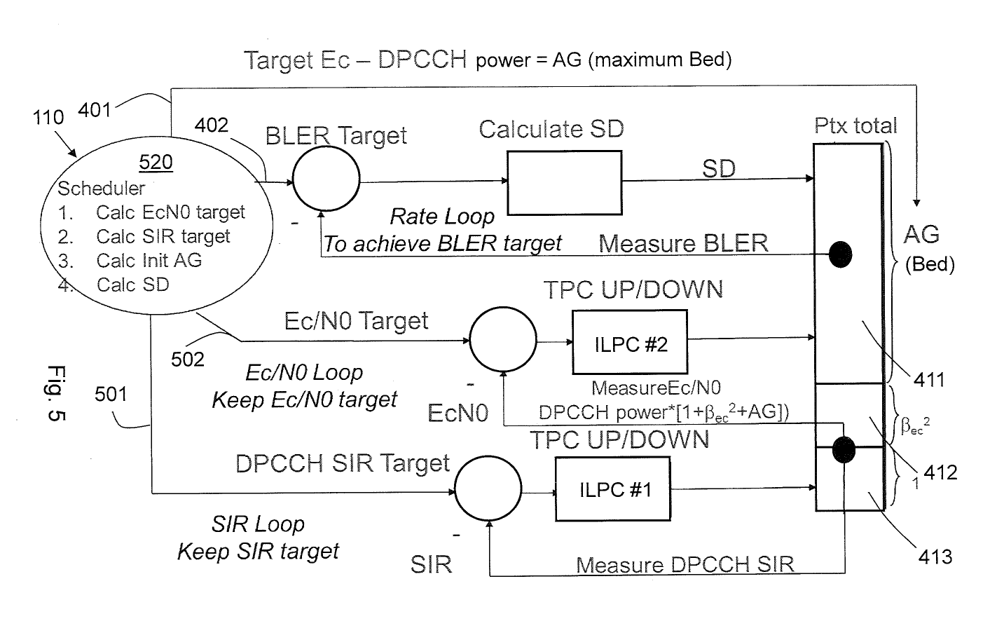

FIG. 5 shows a further schematic flow diagram illustrating the power control and bit rate adaptation according to some embodiments. Here, to achieve a rate adaptation with constant received power (e.g. using ILPC#2 502 in FIG. 5), data BLER control (e.g. using loop 402 in FIG. 5) and DPCCH SINR control (e.g. using ILPC#1 501 in FIG. 5), the following measures may be taken by the network nodes:
Keep an existing DPCCH SINR-based power control loop, ILPC#1 501 in FIG. 5.
Add a second loop, i.e. ILPC#2 502 in FIG. 5, controlling the total received power of the transmission from the user equipment 121.
Since the SINR for traffic data now will vary due to channel conditions, e.g. ISI, and there will be changes in the fraction of power allocated to overhead channels, a back-off value applied to the granted rate may be used by the Node B in order to control the transmission rate and keeping a desirable HARQ retransmission rate. This value may be signalled from Node B 110 to the user equipment 121 through a third control loop, i.e. the rate offset or grant calculation 402 in FIG. 5.

As part of the developing of the some embodiments described herein, some further issues will be discussed in more detail.

The Node B may calculate the total received power of the transmissions form the user equipment 121 based on the DPCCH power and knowledge of the power offsets of the E-DPDCH and E-DPCCH. The power offsets of the E-DPDCH and E-DPCCH may, e.g., be derived by the Node B from the decoded ETFCI in the E-DPCCH. However, with the rate adaptation as described in some embodiments herein, the one-to-one relation between E-TFCI and power offset is broken, i.e., decoupled. Therefore, it may be advantageous that the calculation used by the user equipment 121 is known by the Node B 110, for the Node B 110 to be able to predict it. This is addressed further in detail in the examples of the embodiments described below.

Furthermore, an E-DPCCH boosting is an alternative method to define the power of the E-DPCCH relative to the DPCCH. With E-DPCCH boosting, the E-DPCCH power relation to DPCCH is not fixed, instead the Traffic-to-Total-Pilot power, T2TP, is kept above a specified level, i.e. according to Eq. 9:

E_{edpdch}/(E_{dpcch}+E_{edpcch})>=T2TP (Eq. 9)

where E_{edpdch}, E_{dpcch} and E_{edpcch} are the power allocated to E-DPDCH, DPCCH and E-DPCCH, respectively.

The inequality in Eq. 9 is due to a constraint on the lowest allowed E_{edpcch}. E-DPCCH bosting is performed to enable the use of E-DPCCH assisted channel estimation, which is beneficial when high rates are transmitted. In the 3GPP standard, the use of E-DPCCH boosting is even mandatory for the highest rates, i.e., involving 8PAM/64QAM modulation. This is also addressed further in detail in the examples of the embodiments described below.

In these examples of embodiments, examples of calculations that may be used by the user equipment 121 of transmit powers following reception of power commands from the NodeB, in particular the cases with soft handover and E-DPCCH boosting is described.

Further, according to one aspect, the power offset E_{edpdch}/E_{dpcch} may become too large for reliable channel estimations and control channel performance. This may lead to instability causing the Node B to lose the synchronization of the user equipment. Therefore, in some embodiments, the Node B 110 may signal the maximum and minimum allowed values of the E_{edpdch}/E_{dpcch} to the user equipment 121. Note that, in the current standard, the maximum and minimum allowed values may be controlled by the use of proper reference gain factors.

The restriction of the power offset, however, creates another issue that needs to be addressed. The restriction of the power offset may lead to under- or over-utilization of the granted power to the user equipment 121, both which are undesirable. This is also addressed further in detail in the examples of the embodiments described below.

In these examples of embodiments, examples of operations of the rate adaptation in soft handover are also described. This may include rate adaptation performed in the RNC 140 and signalled to the serving Node B 110.

Also, signalling between Node B's is introduced to enable power measurements to be performed in non-serving cells are also described in these embodiments. This signalling may include rules for how the user equipment 121 combines power control commands from all Node B's in the active set. In some embodiments, this signalling also describes measurements that may be performed by the Node B 110 since the exact control of used power offset may be lost in this case.

Further, and as an alternative, a uplink physical channel is described in some embodiments which may carry information about the actually applied power commands by the user equipment 121, such that all NodeB's may perform accurate power measurements.

Finally, in some embodiments, a way to protect control channel SINR in the serving cell, i.e. serving Node B 110, in the soft handover case is described.

Examples of Embodiments Including Power Measurements by the Node B 100

The power measurement may be performed by first measuring the power of the DPCCH. This may be performed e.g. by despreading pilots symbols transmitted on the DPCCH, calculating the resulting power by using a combination of coherent and non-coherent summation of despread demodulated pilot symbols. If the power of the despread symbols is high enough, also detected non-pilot symbols could be used for power estimation. If the Node B 110 is the only cell in the active set, then by using knowledge of the power commands transmitted to the user equipment 121 and the TPC loop delay, the Node B 110 may compute the power offset of the E-DPCCH and E-DPDCH channels and compute the total received power. This requires that the exact procedure for how the user equipment 121 recalculates the power of DPCCH/E-DPCCH/E-DPDCH based on power control commands is well defined.

In the case of soft handover, the user equipment 121 may combine power control commands, see examples in embodiments below, from several Node B's. This information is not available at all Node B's according to current standards. Therefore, the Node B 110 does not know what power commands the user equipment 121 has used to derive the new power offsets of DPCCH/E-DPCCH/E-DPCCH. One way to address this issue may be that the user equipment 121 relays back the actual used power commands as part of a new DPCCH message to the Node B 110, e.g., as a new slot or by defining a new DPCCH channel.

In case the power offset information is not available, the Node B 110 may measure the power directly on the received E-DPCCH and E-DPDCH channels. In order for this to be possible, the Node B 110 may need to know the spreading factors and number of physical channels used by the user equipment 121. Here, several alternatives are possible, e.g.:
The serving cell signals the granted rate (Absolute grant plus grant offset) to the non-serving cell, either with a direct link or relayed via the RNC 140.
The Node B measures the total power only after it has decoded E-DPCCH and knows what spreading factors, etc. the user equipment 121 is using. This may be performed only after every TTI.
The Node B assumes that the user equipment 121 is using the same format as in the previous TTI.

In all these cases, the Node B 110 has the alternative to measure the total power either each slot or only once per TTI. Since the measurements require despreading of E-DPDCH, which is normally only performed after the E-DPCCH decoding, it appears like per-TTI based total power measurements are preferred in the situations where the Node B 110 is not aware of the power offsets used by the user equipment 121.

Examples of Embodiments Including Power Control Commands

The power control commands may ideally be transmitted every slot. However, for the reasons described above, there may be cases where total power measurements cannot be performed on a per slot basis. Therefore, it may not be meaningful to transmit total power commands in each slot. This may be solved by, in some embodiments, alternating between transmitting only legacy TPC commands and the new TPC commands for both DPCCH and total power.

In some embodiments, a new physical channel may be defined to carry the total power TPC commands. The user equipment 121 may then be required to monitor both channels, and the Node B 110 may have the freedom to transmit total power TPC either per slot or per TTI.

Examples of Embodiments of the User Equipment 121 for the ILPC Loops

As shown in FIG. 5, two fast power control loops are used. In this section, examples of power calculations of the user equipment 121 in response to the two TPC commands according to some embodiments are described.

In these examples, the first command is to increase/decrease the DPCCH power with X dB. The second command is to increase/decrease the total power with Y dB. It is assumed that the user equipment 121 has received commands to change the DPCCH power with a factor ΔP_{c} and that the total power shall change with a factor ΔPₛ.

Thus, assuming at slot “t” the user equipment 121 has allocated the relative powers E_{dpcch} (t), E_{edpcch} (t), E_{edpdch} (t) to the DPCCH, E-DPCCH and E-DPDCH channels, respectively, the following Eq. 10 is obtained for these powers at time “t+1”:

ΔP_{c}(E_{dpcch}(t+1))+E_{edpcch}(t+1)+E_{edpdch}(t+1))=ΔP_{S}(t)E_{c}(t) (Eq. 10)

Note that in Eq. 10, E_{c}(t)=E_{dpcch} (t)+E_{edpcch} (t)+E_{edpdch} (t). Here, it is further assumed, without loss of generality, that E_{dpcch}(t)=E_{dpcch}(t+1).

This results in two remaining unknowns in Eq. 10, namely, E_{edpcch}(t+1) and E_{edpdch}(t+1). If E-DPCCH is not used, then E_{edpcch} (t+1)=E_{edpcch} (t) and Eq. 10 may be solved for the remaining unknown E_{edpdch} (t+1) as in Eq. 11:

E_{edpdch}(t+1)=ΔPₛ(t)E_{c}/ΔP_{c}−E_{dpcch}−E_{edpcch}(t+1) (Eq. 11)

With E-DPCCH boosting, the relation in Eq. 12 exists:

E_{edpdch}(t+1)/(E_{dpcch}+E_{edpcch}(t+1))=T2TP (Eq. 12)

By combining Eq. 10 and Eq. 12, solving for E_{edpcch}(t+1) gives Eq. 13:

ΔP_{c}((1+T2TP(E_{dpcch}+E_{edpcch}(t+1))=ΔPₛE_{c} (Eq. 13)

which leads to Eq. 14:

E_{edpcch}(t+1)=ΔPₛE_{c}/ΔP_{c}(1+T2TP))−E_{dpcch} (Eq. 14

There may also be a requirement on a minimum power E_{edpcch,min} of E_{edpcch}(t+1) (relative to E_{dpcch}) given by the parameter Δ_{EDPCCH}.

If in Eq. 14, E_{edpcch}(t+1)>E_{edpcch,min}, then Eq. 15 follows from Eq. 12:

E_{edpdch}(t+1)=(E_{edpcch}(t+1)+E_{dpcch})T2TP (Eq. 15)

Otherwise, if in Eq. 14, E_{edpcch}(t+1)<=E_{edpcch,min}, then E_{edpcch}(t+1)=E_{edpcch,min} is set and gives Eq. 16 for E_{edpcch}(t+1):

E_{edpdch}(t+1)=ΔPₛ(t)E_{c}/ΔP_{c}−E_{dpcch}−E_{edpcch,min} (Eq. 16)

Thereafter, the result may be checked against maximum and minimum scheduled grants as in Eq. 17:

AGPₘᵢₙ<=E_{edpdch}(t+1)/E_{dpcch}<=AGPₘₐₓ (Eq. 17)

Here, if E_{edpdch}(t+1)/E_{dpcch}=AGₘᵢₙ or AGₘₐₓ then E_{edpcch}(t+1) may be recalculated again using Eq. 11.

The maximum and minimum power offsets AGₘₐₓ and AGₘᵢₙ may, e.g., be signalled to the user equipment 121 in an RRC message.

Assume that user equipment 121 is connected to Nₐ cells. The user equipment 121 may then combine power control commands from all cells in the active set. From the side of the user equipment 121, this may be performed by the user equipment 121 as follows:

ΔPₛ=min(ΔPₛ₁, . . . ΔP_{sNa})

ΔP_{c}=min(ΔP_{c1}, . . . ΔP_{cNa})

where ΔPₛₖ is the total power command from Node B number k, and ΔP_{ck} is the DPCCH power command from Node B number k. When one of the Node Bs is only transmitting ΔP_{ck} (e.g., in all slots or a subset of the slots), then in the calculations above, the ΔPₛₖ for that may be taken to be zero.

SIR and Ec/N0 Target Considerations

In current systems, the load in the serving and non-serving cell is initially controlled by the serving cell, e.g. by selection of Absolute Grant, and the RNC, e.g., by the selection of SIR target, the user equipment should use. If the non-serving cells cannot handle the resulting load, then the non-serving cells may determine to transmit a Relative Grant to the user equipment, whereby the user equipment may lower its rate and transmit power.

However, with the rate adaptation described herein in some embodiments, a slightly different approach may be used. This is because the access grants are not directly related to any power. Instead, the load may be directly controlled by setting an Ec/N0 target, e.g. as shown by ILPC#2 502 in FIG. 5.

For example, as shown in ILPC#2 502 in FIG. 5, the ILPC#2 502 performed in the Node B 110 may adapt the total received power of transmissions from the user equipment 121 on a slot basis using the standardized TPC UP/DOWN commands. The received power of the DPCCH may be measured e.g. by using the known pilots on the DPCCH. The total received power of transmissions from the user equipment 121 may then be estimated by the network node 110 by knowing the power used on E-DPCCH and E-DPDCH, which may be inferred by e.g. the grant, etc.

In some embodiments, the initial Ec/N0 target should, among other things, depend or be based on the load in the serving Node B 110. This Ec/N0 target may in some embodiments be transmitted to the RNC 140, which RNC 140 may then send the Ec/N0 target to the non-serving cells, i.e. other Node B's. Alternatively, a direct link between the serving Node B 110 and the non-serving cells may be used.

Subsequently, when the load changes in the serving cell, an updated Ec/N0 target (i.e. an increase or decrease) may be transmitted by the Node B 110 to the RNC 140 and the non-serving cells. The non-serving cells may thus also be able to update the Ec/N0 targets. It should be noted, however, that in analogy with the Relative Grant operation from non-serving cells, it is probably most meaningful for the non-serving cells to request the Ec/N0 target to be decreased.

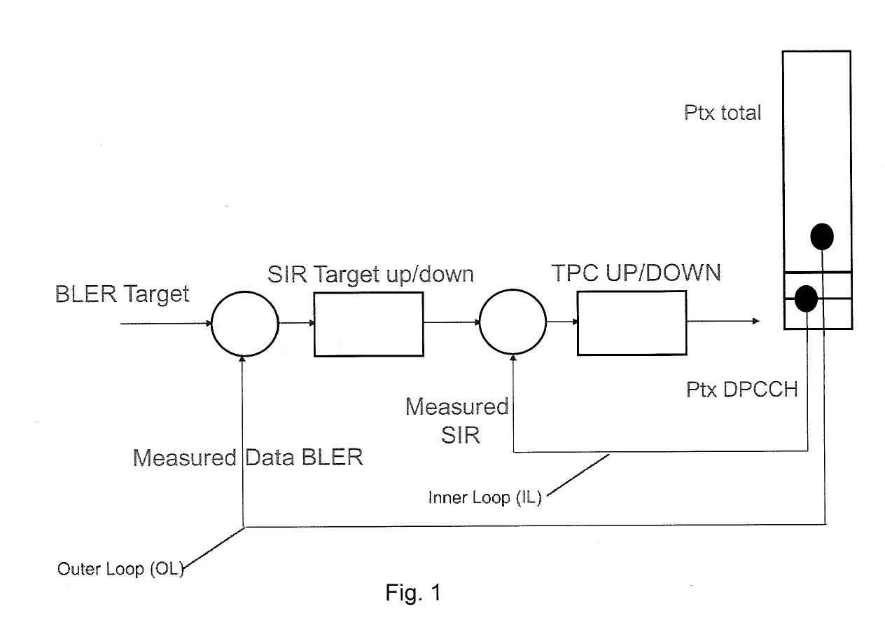

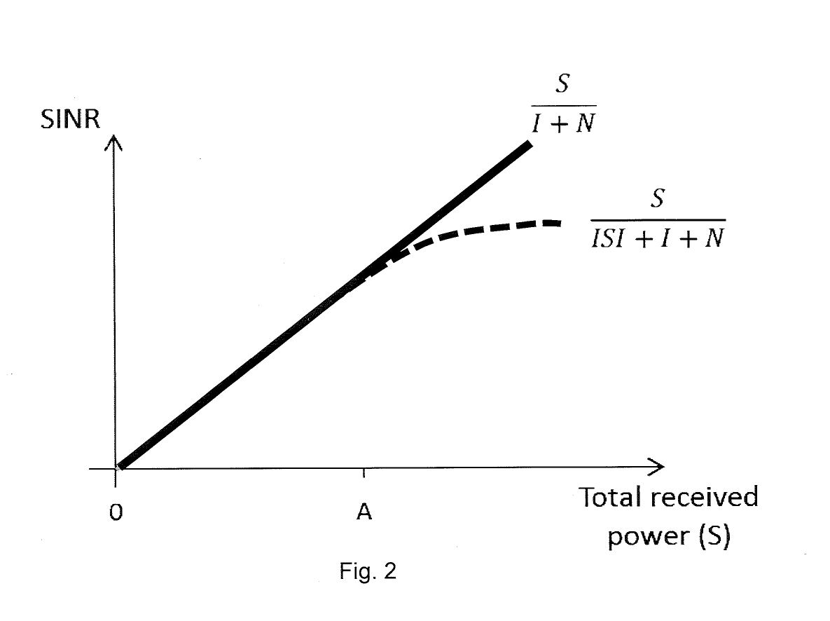

The SIR target is in legacy operation adapted to meet a specified BLER target in addition to providing sufficiently high SINR for control channels and fixed rate services. This may be performed, in some embodiments, with the OLPC algorithm according to FIG. 1.

With rate adaptation, the SIR target is no longer related to BLER performance. It may therefore, e.g., be set at a fixed value. However, there are at least two cases where adaptation of the SIR target, e.g., as shown in ILPC#1 501 in FIG. 5, is desired, that is, in soft handover and/or in order to reduce/avoid under-overutilization of granted power.

In soft handover, the situation may arise that the SINR in the serving cell becomes too low for reliable HS-DPCCH detection. For example, assume, e.g., that a non-serving cell receives the user equipment 121 signal much better than the serving cell and therefore pushes down the SINR in all cells. For decoding E-DPCCH and E-DPDCH, this is not a problem since only one good link between the user equipment 121 and a Node B is needed for reliable E-DPDCH decoding. However, HS_DPCCH is only received by the serving cell. Therefore, the SINR in the serving cell may need to be protected.

Hence, in some embodiments, the serving cell, e.g., Node B 110, may send an indication to RNC 140 requesting that the SINR target is increased in all cells. This may be performed in case the SINR in the serving cell has become too low.

In comparison, for a legacy system operating an OLPC algorithm according to FIG. 1, this indication may serve as an additional decision variable, which may momentarily override the SIR target algorithm based on BLER statistics. In such a legacy system, the BLER statistics will then gradually decrease the SIR target again and again until an SINR target increase indication is received from the serving Node B. Thereby, the situation may be reduced/avoided where SINR is only increased.

However, in the rate adaptation methods described herein, no such coupling exists between SIR target and BLER, so another measure may be used to prevent ever-increasing SIR targets.

In the examples of embodiments including in the user equipment 121 for the ILPC loops described above, two limitations on the granted offset were described. This introduction was motivated also by earlier discussions, namely that the power offset E_{edpdch}/E_{dpcch} may in some situations become too large for reliable channel estimations and control channel performance, e.g. due to self-interference. Similarly, a too small E_{edpdch}/E_{dpcch} may result in a too much control channel overhead.

Following these restrictions, the Ec/N0 target may not be reached. This may then lead to either under- or over-utilization of the granted power. For example, assume that the granted power is at the maximum level AGₘₐₓ, but Ec/N0 may not be reached. In such a case, an increased SIR target, which affects the loop ILPC#2 502, may help to bring up the total power until the AG level is no longer saturated.

An example of an algorithm for modifying the SIR target in the Node B is listed below. Note that in the case where AG is not at its peak level, the SIR target is gradually decreased. This may be performed to ensure that the SIR target is not only increased, which would lead to successively increasing SIR targets, which is undesired. Note that in the legacy scheme, the BLER based algorithm has the role of adjusting SIR targets in both directions.

```
if EcN0 < EcN0target and AG = AGₘₐₓ (under-utilization of Ec/N0)
  SIRtarget = SIRtarget+stepup1
else
  SIRtarget = SIRtarget−stepdown1
End
```

A similar algorithm may be applied to the case of overutilization of power as listed below.

```
if EcN0 > EcN0target and AG = AGₘᵢₙ (over-utilization of Ec/N0)
  SIRtarget = SIRtarget−stepdown2
else
  SIRtarget = SIRtarget+stepup2
End
```

Finally, the resulting SIR targets may be verified against maximum and minimum values. If the SIR target cannot be decreased further, it may be necessary to re-schedule the user equipment 121.

The SIR target calculation may be performed in the Node B 110 or the RNC 140. However, it is an open issue whether the algorithm for correcting under- or over-utilization would be relevant in a soft handover scenario, where the reason for underutilization is not an improperly set SIR target, but rather that the non-serving cell fulfils its Ec/N0 target.

Examples of the Embodiments Including Rate Offset (SD) Calculation

The rate offset calculation 402 in FIGS. 4 and 5 may, in some embodiments, be performed either in the Node B 110 alone, or as described herein, by the RNC 140 when the user equipment 121 is in soft handover. In any case, the rate offset calculation 402 may be based on BLER statistics. If BLER is higher than the desired target, then the offset may be lowered, otherwise it may be increased. In response, the user equipment 121 may then lower/increase the rate, but maintains the relative power of data versus control. One example how this rate offset (SD) calculation may be performed when implemented in the Node B 110 has been described above with reference to FIG. 4.

It should also be noted that some embodiments described above may introduce, according to one aspect, a RNC signalling of, e.g., rate offset (SD) from the RNC 140 to all Node B's in the active set of Node B's in the RNC 140. Also, some embodiments described above may introduce, according to a further aspect, signalling between the RNC 140 and the Node B 110 for starting, stopping and re-starting the rate offset algorithm. Further, some embodiments described above may introduce, according to yet a further aspect, a Node B 110 which may handle rate adaptation by re-using the current OLPC mechanism or procedure between the RNC 140 and the Node B 110. Furthermore, some embodiments described above may introduce, according to yet a further aspect, a Node B which may transmit the AG to the non-serving cells via the RNC 140 or via a direct link. Furthermore, some embodiments described above may introduce, according to yet a further aspect, a RNC 140 which may signal increased Ec/N0 targets to the non-serving cells in cases where the serving cell's SINR becomes too low. Furthermore, some embodiments described above may introduce, according to yet a further aspect, a user equipment 121 configured to signal, on a dedicated physical channel, the actually applied power control commands to Node B 110 every slot. Furthermore, some embodiments described above may introduce, according to yet a further aspect, a Node B 110/RNC 140 capable of performing detailed calculations of relative powers of the DPCCH, the E-DPCCH and the E-DPDCH, after reception of power control commands, from multiple Node B's. Furthermore, some embodiments described above may introduce, according to yet a further aspect, an RNC 140 which may signal maximum and minimum E-DPDCH power offsets to the user equipment 121.

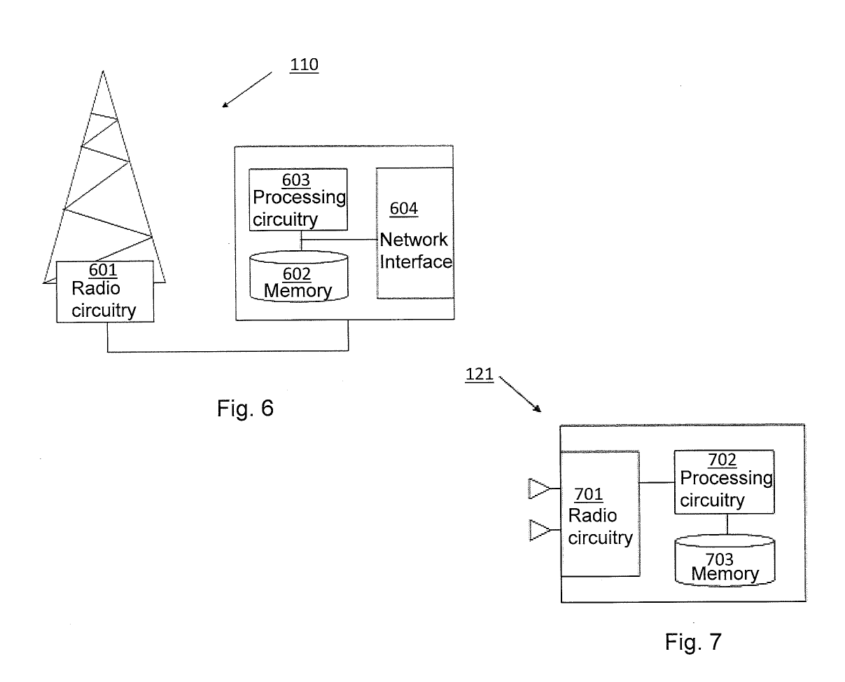

The embodiments presented herein may be utilized in a radio network, which may further include network nodes, such as, a base station 110, as illustrated in FIGS. 3 and 6. The radio network may also include a user equipment 121, as illustrated in FIGS. 3 and 7. It should be appreciated that the examples provided in FIGS. 6 and 7 are shown merely as non-limiting examples. According to the example embodiments, the network node 110 and user equipment 121 may be any other node as described in the examples provided in the above sections.

As shown in FIG. 6, the example network node 110 may include processing circuitry 603, a memory 602, radio circuitry 601, and at least one antenna. The processing circuitry 603 may include RF circuitry and baseband processing circuitry. In particular embodiments, some or all of the functionality described above as being provided by a mobile base station, a base station controller, a relay node, a NodeB, an enhanced NodeB, positioning node, and/or any other type of mobile communications node may be provided by the processing circuitry 603 executing instructions stored on a computer-readable medium, such as the memory 602 shown in FIG. 6. Alternative embodiments of the network node 110 may include additional components responsible for providing additional functionality, including any of the functionality identified above and/or any functionality necessary to support the solution described above. In some example embodiments, a network node may be not equipped with a radio interface or radio circuitry 601.

It should also be appreciated that the processing circuitry, or any other hardware and/or software unit configured to execute operations and/or commands, of the network node 110 illustrated in FIG. 6 may be configured to adapt the maximum bit rate for transmissions to be received from the user equipment 121 based on a threshold value for the amount of reliably detected transmissions from the user equipment 121, while maintaining a determined level of at least one received power of the transmissions from the user equipment 121 as described in the exemplary embodiments provided above.

The network node 110 illustrated in FIG. 6 may further be configured to perform any of the exemplary operations or functions described herein for the embodiments of the network node 110. Also, the processing circuitry 603 in the network node 110 may also include a scheduler or scheduling unit 420, 520 as shown in some of the embodiments above.

An example of a user equipment 121 is provided in FIG. 7. The example user equipment 121 may include processing circuitry 702, a memory 703, radio circuitry 701, and at least one antenna. The radio circuitry 701 may include RF circuitry and baseband processing circuitry. In particular embodiments, some or all of the functionality described above as being provided by mobile communication devices or other forms of wireless device may be provided by the processing circuitry 702 executing instructions stored on a computer-readable medium, such as the memory 703 shown in FIG. 7. Alternative embodiments of the user equipment 121 may include additional components responsible for providing additional functionality, including any of the functionality identified above and/or any functionality necessary to support the solution described above.

It should be appreciated that the processing circuitry (or any other hardware and/or software unit configured to execute operations and/or commands) of the user equipment 121 may be configured to receive the calculated grant value or offset of a grant value, e.g., on an E-AGCH channel. Based on this received calculated grant value or offset of a grant value, the user equipment 121 may be configured to adapt or determine, i.e. lower/increase, the bit rate of its transmissions to the network node 110, and e.g. change the ratio between E-DPDCH and DPCCH. The user equipment 121 may further be configured to perform any of the exemplary operations or functions described in the embodiments herein for the user equipment 121.

Examples of Embodiments in a Node (140)

According to some embodiments, a method may be provided in a node (140) in a wireless telecommunications network (100). The method may include providing (402) an uplink data rate offset value to a serving base station (110) for transmission to a wireless terminal (121) that is in a soft handover. The method may include providing (502) a power budget for the wireless terminal (121) to a non-serving base station of the wireless terminal (121). Moreover, the method may include providing (501) a Signal-to-Interference-plus-Noise Ratio, SINR, target value to the non-serving base station.

The node (140) may be a Radio Network Controller (140) and the method may include receiving the power budget for the wireless terminal (121) from the serving base station (110), at the Radio Network Controller (140). Moreover, providing (502) the power budget may include transmitting the power budget from the Radio Network Controller (140) to the non-serving base station.

The power budget may be a total received power budget in the serving base station (110) for transmissions from the wireless terminal (121), and providing (502) the power budget may include providing the total received power budget in the serving base station (110) for the transmissions from the wireless terminal (121), to the non-serving base station. The non-serving base station may be a first non-serving base station, and providing (502) the total received power budget may include providing the total received power budget in the serving base station (110) for the transmissions from the wireless terminal (121), to the first non-serving base station and to a second non-serving base station.

The SINR target value may include a Dedicated Physical Control Channel, DPCCH, SINR target value. Moreover, providing (501) the SINR target value may include providing the DPCCH SINR target value to the non-serving base station.

The node (140) may be a Radio Network Controller (140), and the method may include receiving, at the Radio Network Controller (140), an indication from the serving base station (110) requesting a change (e.g., an increase or a decrease) of the SINR target value. Moreover, providing (501) the SINR target value may include transmitting, from the Radio Network Controller (140), a changed (e.g., increased or decreased) value of the SINR target value, to the non-serving base station, in response to receiving the indication from the serving base station (110) requesting the change of the SINR target value.

The method may include providing (402) the uplink data rate offset value to the non-serving base station.

The node (140) may be a Radio Network Controller (140), and the method may include determining (402) the uplink data rate offset value at the Radio Network Controller (140) when the wireless terminal (121) is in the soft handover. The uplink data rate offset value may include an offset of a grant value for an uplink data rate of the wireless terminal (121).

The node (140) may be a Radio Network Controller (140), and the method may include providing, at the Radio Network Controller (140), maximum and minimum Enhanced Dedicated Physical Data Channel, E-DPDCH, power offsets for transmission to the wireless terminal (121).

The power budget may include a power-over-thermal-noise target value (E_{c}/N₀), and providing (502) the power budget may include providing the power-over-thermal-noise target value (E_{c}/N₀), to the non-serving base station, for transmissions from the wireless terminal (121), based on available load in the serving base station (110).

According to some embodiments, a node (140) configured to provide communications with a wireless terminal (121) of a wireless telecommunications network (100) through serving (110) and non-serving base stations may be provided. The node (140) may include a network interface (604) configured to provide communications with the serving (110) and non-serving base stations. The node (140) may include processing circuitry (603) coupled to the network interface (604). The processing circuitry (603) may be configured to provide (402) an uplink data rate offset value through the network interface (604) to the serving base station (110) for transmission to the wireless terminal (121), when the wireless terminal (121) is in a soft handover. The processing circuitry (603) may be configured to provide (502) a power budget for the wireless terminal (121), through the network interface (604) to the non-serving base station. Moreover, the processing circuitry (603) may be configured to provide (501) a Signal-to-Interference-plus-Noise Ratio, SINR, target value through the network interface (604) to the non-serving base station.

The node (140) may be a Radio Network Controller (140), and the processing circuitry (603) of the Radio Network Controller (140) may be configured to receive the power budget for the wireless terminal (121) from the serving base station (110) through the network interface (604). Moreover, the processing circuitry (603) may be configured to transmit (502) the power budget from the Radio Network Controller (140) through the network interface (604) to the non-serving base station.

The power budget may be a total received power budget in the serving base station (110) for transmissions from the wireless terminal (121), and the processing circuitry (603) may be configured to provide (502) the total received power budget in the serving base station (110) for the transmissions from the wireless terminal (121), through the network interface (604) to the non-serving base station.

The non-serving base station may be a first non-serving base station, and the processing circuitry (603) may be configured to provide (502) the total received power budget in the serving base station (110) for the transmissions from the wireless terminal (121), through the network interface (604) to the first non-serving base station and to a second non-serving base station.

The processing circuitry (603) may be configured to provide (502) the power budget without consideration of the data rate offset value.

The processing circuitry (603) of the Radio Network Controller (140) may be configured to receive an indication from the serving base station (110) through the network interface (604) requesting a change (e.g., an increase or a decrease) of the SINR target value.

The processing circuitry (603) of the Radio Network Controller (140) may be configured to transmit a changed (e.g., an increased or decreased) value of the SINR target value, through the network interface (604) to the non-serving base station, in response to receiving the indication from the serving base station (110) requesting the change of the SINR target value.

The processing circuitry (603) may be configured to provide (402) the uplink data rate offset value through the network interface (604) to the non-serving base station.

The node (140) may be a Radio Network Controller (140), and the processing circuitry (603) of the Radio Network Controller (140) may be configured to determine (402) the uplink data rate offset value when the wireless terminal (121) is in the soft handover. The uplink data rate offset value may be an offset of a grant value for an uplink data rate of the wireless terminal (121).

The processing circuitry (603) may be configured to provide maximum and minimum Enhanced Dedicated Physical Data Channel, E-DPDCH, power offsets for transmission to the wireless terminal (121).

The power budget may include a power-over-thermal-noise target value (E_{c}/N₀), and the processing circuitry (603) may be configured to provide (502) the power-over-thermal-noise target value (E_{c}/N₀), through the network interface (604) to the non-serving base station, for transmissions from the wireless terminal (121), based on available load in the serving base station (110).

Examples of Embodiments in a Node (110)

According to some embodiments, a method in a node (110) in a wireless telecommunications network (100) may be provided. The method may include receiving (402) an uplink data rate offset value from a Radio Network Controller (140). The method may include transmitting the uplink data rate offset value to a wireless terminal (121) that is in a soft handover. The method may include determining a power budget for the wireless terminal (121). The method may include transmitting (502) the power budget to the Radio Network Controller (140) for transmission to a non-serving base station. Moreover, the method may include transmitting (501) to the Radio Network Controller (140) an indication requesting a change (e.g., an increase or a decrease) of a Signal-to-Interference-plus-Noise Ratio, SINR, target value.

The node (110) may be a serving base station (110), and receiving (402) the uplink data rate offset value may include receiving (402) the uplink data rate offset value at the serving base station (110) from the Radio Network Controller (140). Transmitting the uplink data rate offset value may include transmitting the uplink data rate offset value from the serving base station (110) to the wireless terminal (121) that is in the soft handover. Determining the power budget may include determining the power budget for the wireless terminal (121) at the serving base station (110). Transmitting (502) the power budget may include transmitting (502) the power budget from the serving base station (110) to the Radio Network Controller (140) for transmission to the non-serving base station.

The power budget may include a total power budget for transmissions from the wireless terminal (121), and transmitting (502) the power budget may include transmitting the total power budget for the transmissions from the wireless terminal (121), to the Radio Network Controller (140) for transmission to the non-serving base station.

The node (110) may be a serving base station (110), and transmitting (501) to the Radio Network Controller (140) may include transmitting the indication requesting the change (e.g., increase or decrease) of the SINR target value from the serving base station (110) to the Radio Network Controller (140).

The node (110) may include a serving base station (110), and the power budget may include a power-over-thermal-noise target value (E_{c}/N₀). Determining the power budget for the wireless terminal (121) may include determining, at the serving base station (110), the power-over-thermal-noise target value (E_{c}/N₀), based on available load in the serving base station (110). Transmitting (502) the power budget may include transmitting the power-over-thermal-noise target value (E_{c}/N₀) from the serving base station (110) to the Radio Network Controller (140) for transmission to the non-serving base station.

The method may include transmitting (502) a first power control command to the wireless terminal (121). The first power control command requests a change in total transmit power of the wireless terminal (121). Moreover, the method may include transmitting (501) a second power control command to the wireless terminal (121). The second power control command requests a change in Dedicated Physical Control Channel, DPCCH, transmit power of the wireless terminal (121).

In some embodiments, the method may include comparing a value of the total transmit power of the wireless terminal (121) with a total transmit power target value, and comparing a value of the DPCCH transmit power of the wireless terminal (121) with a DPCCH transmit power target value. Moreover, transmitting (502) the first power control command may include transmitting the first power control command in response to comparing the value of the total transmit power of the wireless terminal (121) with the total transmit power target value, and transmitting (501) the second power control command may include transmitting the second power control command in response to comparing the value of the DPCCH transmit power of the wireless terminal (121) with the DPCCH transmit power target value.

According to some embodiments, a node (110) in a wireless telecommunications network (100) may be provided. The node (110) may include radio circuitry (601) configured to provide communications with a wireless terminal (121) that is in a soft handover. The node (110) may include a network interface (604) configured to provide communications with a Radio Network Controller (140) and processing circuitry (603) coupled to the radio circuitry (601) and the network interface (604). The processing circuitry (603) may be configured to receive (402) an uplink data rate offset value from the Radio Network Controller (140) through the network interface (604). The processing circuitry (603) may be configured to transmit the uplink data rate offset value to the wireless terminal (121) that is in the soft handover. The processing circuitry (603) may be configured to determine a power budget for the wireless terminal (121). The processing circuitry (603) may be configured to transmit (502) the power budget to the Radio Network Controller (140) for transmission to a non-serving base station. Moreover, the processing circuitry (603) may be configured to transmit (501) to the Radio Network Controller (140) an indication requesting a change (e.g., an increase or a decrease) of a Signal-to-Interference-plus-Noise Ratio, SINR, target value.

The node (110) may be a serving base station (110), and the processing circuitry (603) may be configured to receive (402) the uplink data rate offset value at the serving base station (110) from the Radio Network Controller (140) through the network interface (604). The processing circuitry (603) may be configured to transmit, through the radio circuitry (601), the uplink data rate offset value from the serving base station (110) to the wireless terminal (121) that is in the soft handover. The processing circuitry (603) may be configured to determine the power budget for the wireless terminal (121) at the serving base station (110). Moreover, the processing circuitry (603) may be configured to transmit (502) the power budget from the serving base station (110) through the network interface (604) to the Radio Network Controller (140) for transmission to the non-serving base station.

The power budget may be a total received power budget in the node (110) for transmissions from the wireless terminal (121), and the processing circuitry (603) may be configured to transmit (502) the total received power budget in the node (110) for the transmissions from the wireless terminal (121), through the network interface (604) to the Radio Network Controller (140) for transmission to the non-serving base station.

The node (110) may be a serving base station (110), and the processing circuitry (603) may be configured to transmit (501) through the network interface (604) the indication requesting the change of the SINR target value from the serving base station (110) to the Radio Network Controller (140).

The node (110) may be a serving base station (110), and the power budget may include a power-over-thermal-noise target value (E_{c}/N₀). Moreover, the processing circuitry (603) may be configured to determine, at the serving base station (110), the power-over-thermal-noise target value (E_{c}/N₀), based on available load in the serving base station (110). The processing circuitry (603) may be configured to transmit (502) the power-over-thermal-noise target value (E_{c}/N₀) from the serving base station (110) through the network interface (604) to the Radio Network Controller (140) for transmission to the non-serving base station.

The processing circuitry (603) may be configured to transmit (502), through the radio circuitry (601), a first power control command to the wireless terminal (121). The first power control command requests a change in total transmit power of the wireless terminal (121). Moreover, the processing circuitry (603) may be configured to transmit (501), through the radio circuitry (601), a second power control command to the wireless terminal (121). The second power control command requests a change in Dedicated Physical Control Channel, DPCCH, transmit power of the wireless terminal (121).

The processing circuitry (603) may be configured to compare a value of the total transmit power of the wireless terminal (121) with a total transmit power target value. The processing circuitry (603) may be configured to compare a value of the DPCCH transmit power of the wireless terminal (121) with a DPCCH transmit power target value. The processing circuitry (603) may be configured to transmit (502) the first power control command in response to comparing the value of the total transmit power of the wireless terminal (121) with the total transmit power target value. Moreover, the processing circuitry (603) may be configured to transmit (501) the second power control command in response to comparing the value of the DPCCH transmit power of the wireless terminal (121) with the DPCCH transmit power target value.

Examples of Embodiments in a Wireless Terminal (UE)

According to some embodiments, a method in a wireless terminal (121) may be provided. The method may include transmitting an uplink data block to a non-serving base station and/or a serving base station (110) when the wireless terminal (121) is in a soft handover with respect to the serving base station (110) and the non-serving base station. The method may then include receiving (402) an uplink data rate offset value from the serving base station (110). The method may include receiving (502) a first power control command from the serving base station (110). The first power control command requests a change in total transmit power of (e.g., total power of transmissions by) the wireless terminal (121). Moreover, the method may include receiving (501) a second power control command from the serving base station (110). The second power control command requests a change in Dedicated Physical Control Channel, DPCCH, transmit power of the wireless terminal (121).

The method may include receiving a first plurality of power control commands from a plurality of cells requesting changes in the total transmit power of the wireless terminal (121). The method may include receiving a second plurality of power control commands from the plurality of cells requesting changes in the DPCCH transmit power of the wireless terminal (121). Moreover, the first power control command may include a first minimum (e.g., lowest) value among the first plurality of power control commands, and the second power control command may include a second minimum value among the second plurality of power control commands.

According to some embodiments, a wireless terminal (121) may be provided. The wireless terminal (121) may include radio circuitry (701) configured to provide communications with a non-serving base station and a serving base station (110). The wireless terminal (121) may include processing circuitry (702) coupled to the radio circuitry (701). The processing circuitry (702) may be configured to transmit, through the radio circuitry (701), an uplink data block to the non-serving base station and/or the serving base station (110) when the wireless terminal (121) is in a soft handover with respect to the serving base station (110) and the non-serving base station. The processing circuitry (702) may be configured to then receive (402), through the radio circuitry (701), an uplink data rate offset value from the serving base station (110). The processing circuitry (702) may be configured to receive (502), through the radio circuitry (701), a first power control command from the serving base station (110). The first power control command requests a change in total transmit power of the wireless terminal (121). Moreover, the processing circuitry (702) may be configured to receive (501), through the radio circuitry (701), a second power control command from the serving base station (110). The second power control command requests a change in Dedicated Physical Control Channel, DPCCH, transmit power of the wireless terminal (121).

The processing circuitry (702) may be configured to receive, through the radio circuitry (701), a first plurality of power control commands from a plurality of cells, requesting changes in the total transmit power of the wireless terminal (121). The processing circuitry (702) may be configured to receive, through the radio circuitry (701), a second plurality of power control commands from the plurality of cells, requesting changes in the DPCCH transmit power of the wireless terminal (121). The first power control command may include a first minimum value among the first plurality of power control commands, and the second power control command may include a second minimum value among the second plurality of power control commands.

The description of the example embodiments provided herein has been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

A “device” as the term is used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) terminal that may combine a cellular radiotelephone with data processing; a personal digital assistant (PDA) that may include a radiotelephone or wireless communication system; a laptop; a camera (e.g., video and/or still image camera) having communication ability; and any other computation or communication device capable of transceiving, such as a personal computer, a home entertainment system, a television, etc.

Although the description is mainly given for a user equipment, as measuring or recording unit, it should be understood by the skilled in the art that “user equipment” is a non-limiting term which means any wireless device or node capable of receiving in downlink and transmitting in uplink (e.g. PDA, laptop, mobile, sensor, fixed relay, mobile relay or even a radio base station, e.g. femto base station).

A cell is associated with a radio node, where a radio node or radio network node or eNodeB may be used interchangeably in the description of the embodiments, which may include in a general sense any node transmitting radio signals used for measurements, e.g., eNodeB, macro/micro/pico base station, home eNodeB, relay, beacon device, or repeater. A radio node herein may include a radio node operating in one or more frequencies or frequency bands. It may also be a single- or muti-RAT node. A multi-RAT node may include a node with co-located RATs or supporting multi-standard radio (MSR) or a mixed radio node.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The embodiments herein are not limited to the above described embodiments. Various alternatives, modifications and equivalents may be used. Therefore, the above embodiments should not be construed as limiting.

1-37. (canceled)

38. A method in a node in a wireless telecommunications network, the method comprising:
providing an uplink data rate offset value to a serving base station for transmission to a wireless terminal that is in a soft handover;
providing a power budget for the wireless terminal to a non-serving base station of the wireless terminal; and
providing a Signal-to-Interference-plus-Noise Ratio, SINR, target value to the non-serving base station.

39. The method of claim 38,
wherein the node comprises a Radio Network Controller,
wherein the method further comprises receiving the power budget for the wireless terminal from the serving base station, at the Radio Network Controller, and
wherein providing the power budget comprises transmitting the power budget from the Radio Network Controller to the non-serving base station.

40. The method of claim 38,
wherein the power budget comprises a total received power budget in the serving base station for transmissions from the wireless terminal, and
wherein providing the power budget comprises providing the total received power budget in the serving base station for the transmissions from the wireless terminal, to the non-serving base station.

41. The method of claim 40,
wherein the non-serving base station comprises a first non-serving base station, and
wherein providing the total received power budget comprises providing the total received power budget in the serving base station for the transmissions from the wireless terminal, to the first non-serving base station and to a second non-serving base station.

42. The method of claim 38,
wherein the SINR target value comprises a Dedicated Physical Control Channel, DPCCH, SINR target value, and
wherein providing the SINR target value comprises providing the DPCCH SINR target value to the non-serving base station.

43. The method of claim 38,
wherein the node comprises a Radio Network Controller, and
wherein the method further comprises:
receiving, at the Radio Network Controller, an indication from the serving base station requesting a change of the SINR target value.

44. The method of claim 43, wherein providing the SINR target value comprises:
transmitting, from the Radio Network Controller, a changed value of the SINR target value, to the non-serving base station, in response to receiving the indication from the serving base station requesting the change of the SINR target value.

45. The method of claim 38,
wherein the node comprises a Radio Network Controller,
wherein the method further comprises:
determining the uplink data rate offset value at the Radio Network Controller when the wireless terminal is in the soft handover, and
wherein the uplink data rate offset value comprises an offset of a grant value for an uplink data rate of the wireless terminal.

46. The method of claim 38,
wherein the node comprises a Radio Network Controller, and
wherein the method further comprises:
providing, at the Radio Network Controller, maximum and minimum Enhanced Dedicated Physical Data Channel, E-DPDCH, power offsets for transmission to the wireless terminal.

47. The method of claim 38,
wherein the power budget comprises a power-over-thermal-noise target value (E_{c}/N₀), and
wherein providing the power budget comprises providing the power-over-thermal-noise target value, to the non-serving base station, for transmissions from the wireless terminal, based on available load in the serving base station.

48. A node configured to provide communications with a wireless terminal of a wireless telecommunications network through serving and non-serving base stations, the node comprising:
a network interface configured to provide communications with the serving and non-serving base stations; and
processing circuitry coupled to the network interface, wherein the processing circuitry is configured to:
provide an uplink data rate offset value through the network interface to the serving base station for transmission to the wireless terminal, when the wireless terminal is in a soft handover;
provide a power budget for the wireless terminal, through the network interface to the non-serving base station; and
provide a Signal-to-Interference-plus-Noise Ratio, SINR, target value through the network interface to the non-serving base station.

49. The node of claim 48,
wherein the node comprises a Radio Network Controller,
wherein the processing circuitry of the Radio Network Controller is configured to receive the power budget for the wireless terminal from the serving base station through the network interface, and
wherein the processing circuitry is configured to transmit the power budget from the Radio Network Controller through the network interface to the non-serving base station.

50. The node of claim 48,
wherein the power budget comprises a total received power budget in the serving base station for transmissions from the wireless terminal, and
wherein the processing circuitry is configured to provide the total received power budget in the serving base station for the transmissions from the wireless terminal, through the network interface to the non-serving base station.

51. The node of claim 50,
wherein the non-serving base station comprises a first non-serving base station, and
wherein the processing circuitry is configured to provide the total received power budget in the serving base station for the transmissions from the wireless terminal, through the network interface to the first non-serving base station and to a second non-serving base station.

52. The node of claim 51, wherein the processing circuitry of the Radio Network Controller is configured to receive an indication from the serving base station through the network interface requesting a change of the SINR target value.

53. The node of claim 52, wherein the processing circuitry of the Radio Network Controller is configured to transmit a changed value of the SINR target value, through the network interface to the non-serving base station, in response to receiving the indication from the serving base station requesting the change of the SINR target value.

54. The node of claim 48,
wherein the node comprises a Radio Network Controller,
wherein the processing circuitry of the Radio Network Controller is configured to determine the uplink data rate offset value when the wireless terminal is in the soft handover, and
wherein the uplink data rate offset value comprises an offset of a grant value for an uplink data rate of the wireless terminal.

55. The node of claim 48, wherein the processing circuitry is configured to provide maximum and minimum Enhanced Dedicated Physical Data Channel, E-DPDCH, power offsets for transmission to the wireless terminal.

56. The node of claim 48,
wherein the power budget comprises a power-over-thermal-noise target value (E_{c}/N₀), and
wherein the processing circuitry is configured to provide the power-over-thermal-noise target value, through the network interface to the non-serving base station, for transmissions from the wireless terminal, based on available load in the serving base station.

57. A method in a node in a wireless telecommunications network, the method comprising:
receiving an uplink data rate offset value from a Radio Network Controller;
transmitting the uplink data rate offset value to a wireless terminal that is in a soft handover;
determining a power budget for the wireless terminal;
transmitting the power budget to the Radio Network Controller for transmission to a non-serving base station; and
transmitting to the Radio Network Controller an indication requesting a change of a Signal-to-Interference-plus-Noise Ratio, SINR, target value.

58. The method of claim 57,
wherein the node comprises a serving base station,
wherein receiving the uplink data rate offset value comprises receiving the uplink data rate offset value at the serving base station from the Radio Network Controller,
wherein transmitting the uplink data rate offset value comprises transmitting the uplink data rate offset value from the serving base station to the wireless terminal that is in the soft handover,
wherein determining the power budget comprises determining the power budget for the wireless terminal at the serving base station, and
wherein transmitting the power budget comprises transmitting the power budget from the serving base station to the Radio Network Controller for transmission to the non-serving base station.

59. The method of claim 57,
wherein the power budget comprises a total received power budget in the node for transmissions from the wireless terminal, and
wherein transmitting the power budget comprises transmitting the total received power budget in the node for the transmissions from the wireless terminal, to the Radio Network Controller for transmission to the non-serving base station.

60. The method of claim 57,
wherein the node comprises a serving base station, and
wherein transmitting to the Radio Network Controller comprises transmitting the indication requesting the change of the SINR target value from the serving base station to the Radio Network Controller.

61. The method of claim 57,
wherein the node comprises a serving base station,
wherein the power budget comprises a power-over-thermal-noise target value,
wherein determining the power budget for the wireless terminal comprises determining, at the serving base station, the power-over-thermal-noise target value, based on available load in the serving base station, and
wherein transmitting the power budget comprises transmitting the power-over-thermal-noise target value from the serving base station to the Radio Network Controller for transmission to the non-serving base station.

62. The method of claim 57, further comprising:
transmitting a first power control command to the wireless terminal, wherein the first power control command requests a change in total transmit power of the wireless terminal; and
transmitting a second power control command to the wireless terminal, wherein the second power control command requests a change in Dedicated Physical Control Channel, DPCCH, transmit power of the wireless terminal.

63. The method of claim 62, further comprising:
comparing a value of the total transmit power of the wireless terminal with a total transmit power target value; and
comparing a value of the DPCCH transmit power of the wireless terminal with a DPCCH transmit power target value,
wherein transmitting the first power control command comprises transmitting the first power control command in response to comparing the value of the total transmit power of the wireless terminal with the total transmit power target value, and
wherein transmitting the second power control command comprises transmitting the second power control command in response to comparing the value of the DPCCH transmit power of the wireless terminal with the DPCCH transmit power target value.

64. A node in a wireless telecommunications network, the node comprising:
radio circuitry configured to provide communications with a wireless terminal that is in a soft handover;
a network interface configured to provide communications with a Radio Network Controller; and
processing circuitry coupled to the radio circuitry and the network interface, wherein the processing circuitry is configured to:
receive an uplink data rate offset value from the Radio Network Controller through the network interface;
transmit the uplink data rate offset value to the wireless terminal that is in the soft handover;
determine a power budget for the wireless terminal;
transmit the power budget to the Radio Network Controller for transmission to a non-serving base station; and
transmit to the Radio Network Controller an indication requesting a change of a Signal-to-Interference-plus-Noise Ratio, SINR, target value.

65. The node of claim 64,
wherein the node comprises a serving base station, and
wherein the processing circuitry is configured to:
receive the uplink data rate offset value at the serving base station from the Radio Network Controller through the network interface;
transmit, through the radio circuitry, the uplink data rate offset value from the serving base station to the wireless terminal that is in the soft handover;
determine the power budget for the wireless terminal at the serving base station; and
transmit the power budget from the serving base station through the network interface to the Radio Network Controller for transmission to the non-serving base station.

66. The node of claim 64,
wherein the power budget comprises a total received power budget in the node for transmissions from the wireless terminal, and
wherein the processing circuitry is configured to transmit the total received power budget in the node for the transmissions from the wireless terminal, through the network interface to the Radio Network Controller for transmission to the non-serving base station.

67. The node of claim 64,
wherein the node comprises a serving base station, and
wherein the processing circuitry is configured to transmit through the network interface the indication requesting the change of the SINR target value from the serving base station to the Radio Network Controller.

68. The node of claim 64,
wherein the node comprises a serving base station,
wherein the power budget comprises a power-over-thermal-noise target value (E_{c}/N₀), and
wherein the processing circuitry is configured to:
determine, at the serving base station, the power-over-thermal-noise target value, based on available load in the serving base station; and
transmit the power-over-thermal-noise target value from the serving base station through the network interface to the Radio Network Controller for transmission to the non-serving base station.

69. The node of claim 64, wherein the processing circuitry is configured to:
transmit, through the radio circuitry, a first power control command to the wireless terminal, wherein the first power control command requests a change in total transmit power of the wireless terminal; and
transmit, through the radio circuitry, a second power control command to the wireless terminal, wherein the second power control command requests a change in Dedicated Physical Control Channel, DPCCH, transmit power of the wireless terminal.

70. The node of claim 69, wherein the processing circuitry is configured to:
compare a value of the total transmit power of the wireless terminal with a total transmit power target value;
compare a value of the DPCCH transmit power of the wireless terminal with a DPCCH transmit power target value;
transmit the first power control command in response to comparing the value of the total transmit power of the wireless terminal with the total transmit power target value, and
transmit the second power control command in response to comparing the value of the DPCCH transmit power of the wireless terminal with the DPCCH transmit power target value.

71. A method in a wireless terminal, the method comprising:
transmitting an uplink data block to a non-serving base station and/or a serving base station when the wireless terminal is in a soft handover with respect to the serving base station and the non-serving base station; then
receiving an uplink data rate offset value from the serving base station;
receiving a first power control command from the serving base station, wherein the first power control command requests a change in total transmit power of the wireless terminal; and
receiving a second power control command from the serving base station, wherein the second power control command requests a change in Dedicated Physical Control Channel, DPCCH, transmit power of the wireless terminal.

72. The method of claim 71, further comprising:
receiving a first plurality of power control commands from a plurality of cells requesting changes in the total transmit power of the wireless terminal; and
receiving a second plurality of power control commands from the plurality of cells requesting changes in the DPCCH transmit power of the wireless terminal,
wherein the first power control command comprises a first minimum value among the first plurality of power control commands, and
wherein the second power control command comprises a second minimum value among the second plurality of power control commands.

73. A wireless terminal comprising:
radio circuitry configured to provide communications with a non-serving base station and a serving base station; and
processing circuitry coupled to the radio circuitry, wherein the processing circuitry is configured to:
transmit, through the radio circuitry, an uplink data block to the non-serving base station and/or the serving base station when the wireless terminal is in a soft handover with respect to the serving base station and the non-serving base station; then
receive, through the radio circuitry, an uplink data rate offset value from the serving base station;
receive, through the radio circuitry, a first power control command from the serving base station, wherein the first power control command requests a change in total transmit power of the wireless terminal; and
receive, through the radio circuitry, a second power control command from the serving base station, wherein the second power control command requests a change in Dedicated Physical Control Channel, DPCCH, transmit power of the wireless terminal.

74. The wireless terminal of claim 73, wherein the processing circuitry is configured to:
receive, through the radio circuitry, a first plurality of power control commands from a plurality of cells, requesting changes in the total transmit power of the wireless terminal; and
receive, through the radio circuitry, a second plurality of power control commands from the plurality of cells, requesting changes in the DPCCH transmit power of the wireless terminal,
wherein the first power control command comprises a first minimum value among the first plurality of power control commands, and
wherein the second power control command comprises a second minimum value among the second plurality of power control commands.
